(19) United States
(12) Patent Application Publication
(10) Pub. No.: US 2007/0143596 A1
(43) Pub. Date: Jun. 21, 2007

(54) Untrusted certificate store for secure e-mail

(75) Inventors: Andrew S. Myers, Wayland, MA (US); John C. Wray, Chelmsford, MA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/304,112

(22) Filed: Dec. 15, 2005

(51) Int. Cl. H04L 9/00

(52) U.S. Cl. 713/156

(57) ABSTRACT

Under the present invention, a method, system, and program product for providing an untrusted certificate store for secure e-mail is provided. The method for providing the untrusted certificate store (UCS) includes obtaining particular information from either an e-mail message or directory that includes either, or both of, an untrusted certificate and an e-mail address and storing it/them in the UCS and then automatically maintaining the information in the UCS.

### BACKGROUND OF THE INVENTION

1. Field of the Invention

The present invention relates generally to electronic mail (e-mail) and an improvement in asymmetric cryptography. More specifically, the present invention provides a method, system, and computer program product for providing a maintained untrusted certificate store for secure e-mail.

2. Background Art

In the field of electronic mail (e-mail), cryptography, public key infrastructure (PKI), and asymmetric cryptography are known in the art.

A typical public key system, or infrastructure, may include a trusted authority (e.g., certificate authority (CA)) that issues and verifies a digital certificate (i.e., encryption certificate), wherein the certificate includes a public key, a name, and possibly additional information about the public key or named entity, and also one, or more, directories where the certificates with their associated public keys are held. This allows users to use an unsecure network (e.g., Internet) to securely exchange information (e.g. e-mail).

Currently, when sending encrypted e-mail, the e-mail sender must obtain the encryption certificate for the intended recipient(s) of the e-mail. Typically, the encryption certificate is obtained from a directory, which precludes the sending of encrypted e-mail when the user is disconnected from the directory (i.e., “off-line”).

Corporations often keep directories. However, these corporate directories typically do not store certificates for individuals who are not employees of the corporation. As such, outside e-mail (i.e., e-mail not originating from the corporation) cannot have the benefit of being encrypted. This is problematic too, for example, when employees of the corporation are attempting to communicate when working off-line, from home, e-commuting, and the like.

E-mail users may opt to keep a “local” store to keep certificates of frequent correspondents for use when communicating off-line (e.g., disconnected from corporation directory). These local store(s) are not kept up to date automatically and a typical e-mail user does not have a knowledge to properly manage the upkeep of the store manually.

In view of the foregoing, there exists a need for a method, system, and program product for providing a maintained untrusted certificate store for secure e-mail.

### SUMMARY OF THE INVENTION

In general, the present invention provides a method, system and program product for providing an untrusted certificate store for secure e-mail.

A first aspect of the present invention provides a method of providing an untrusted certificate store (UCS) for secure e-mail, comprising the steps of: obtaining information from one selected from the group consisting of an e-mail message and a directory, wherein the information comprises at least one of an untrusted certificate and an e-mail address; storing the information in an UCS; and automatically maintaining the information.

A second aspect of the present invention provides a system for providing an untrusted certificate store (UCS) for secure e-mail comprising: a system for obtaining information from one selected from the group consisting of an e-mail message and a directory, wherein the information comprises at least one of an untrusted certificate and an e-mail address; a system for storing the information in an UCS; and a system for automatically maintaining the information.

A third aspect of the present invention provides a program product stored on a computer readable medium for providing an untrusted certificate store (UCS) for secure e-mail, the computer readable medium comprising program code for performing the steps of: obtaining information from one selected from the group consisting of an e-mail message and a directory, wherein the information comprises at least one of an untrusted certificate and an e-mail address; storing the information in an UCS; and automatically maintaining the information.

A fourth aspect of the present invention provides deploying an application for providing an untrusted certificate store (UCS) for secure e-mail, comprising: providing a computer infrastructure being operable to: obtain information from one selected from the group consisting of an e-mail message and a directory, wherein the information comprises at least one of an untrusted certificate and an e-mail address; store the information in an UCS; and automatically maintain the information.

A fifth aspect of the present invention provides computer software embodied in a propagated signal for providing an untrusted certificate store (UCS) for secure e-mail, the computer software comprising instructions to cause a computer system to perform the following functions: obtaining information from one selected from the group consisting of an e-mail message and a directory, wherein the information comprises at least one of an untrusted certificate and an e-mail address; storing the information in an UCS; and automatically maintaining the information.

Therefore, the present invention provides a method, system, and program product for providing an untrusted certificate store for secure e-mail.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system employing an untrusted certificate store (UCS) for secure e-mail, in accordance with the present invention.

FIG. 2 depicts a schematic view of a UCS in an environment, in accordance with the present invention.

FIG. 3 depicts a flow diagram for a receiving e-mail portion of a method for providing a UCS for secure e-mail in accordance with the present invention.

FIG. 4 depicts a flow diagram for a receiving e-mail portion of a method for providing a UCS for secure e-mail in accordance with the present invention.

FIG. 5 depicts a flow diagram for a sending e-mail portion of a method for providing a UCS for secure e-mail in accordance with the present invention.

FIG. 6 depicts a flow diagram for a sending e-mail portion of a method for providing a UCS for secure e-mail in accordance with the present invention.

FIG. 7 depicts a flow diagram for a management of a UCS portion of a method for providing a UCS for secure e-mail in accordance with the present invention. FIG. 8 depicts a flow diagram for a management of a UCS portion of a method for providing a UCS for secure e-mail in accordance with the present invention.

FIG. 9 depicts a flow diagram for a management of a UCS portion of a method for providing a UCS for secure e-mail in accordance with the present invention.

FIG. 10 depicts a computerized system for providing a UCS for securing e-mail in accordance with the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system and program product for providing an untrusted certificate store (UCS) for secure e-mail. In accordance with the present invention, a persistent cache is created for the user that allows for the storage of untrusted certificates, yet is periodically and automatically maintained so as to ultimately allow for improved secure e-mail transactions both when on and off-line.

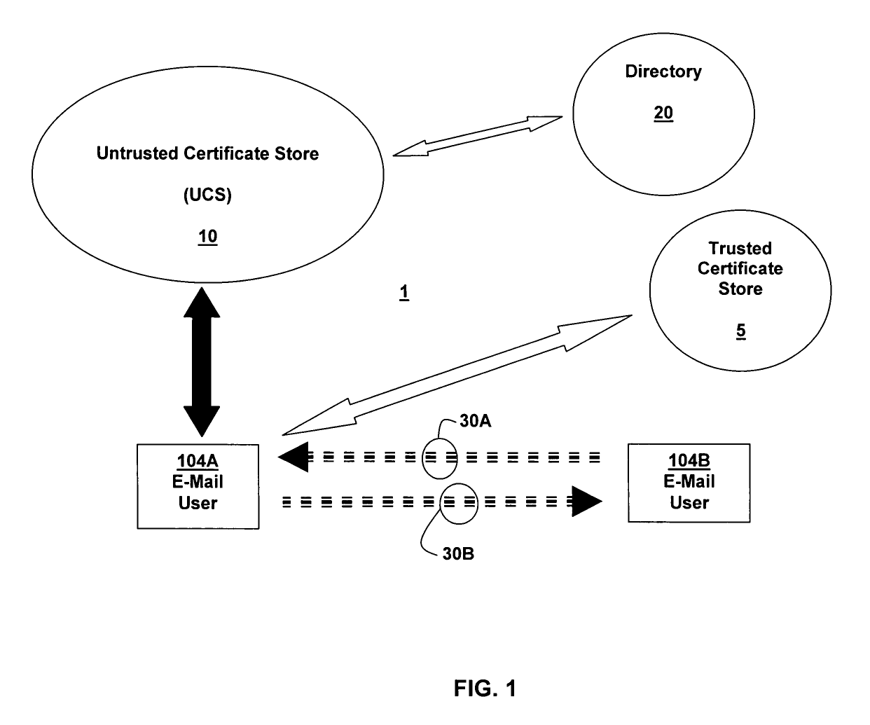

FIG. 1 shows an electronic communication system (e.g., e-mail), depicted as 1. The system 1 includes two email users 104 (e.g., “E-Mail User 104A” and “E-Mail User 104B”) that communicate via the sending and receiving of e-mail messages 30, as is known in the art. For illustrative purposes of the embodiment in FIG. 1, E-Mail User 104A will employ and be in constant communication with a UCS 10. As will be described in detail, the UCS 10 may be in periodic communication with a directory 20 and a trusted certificate store 5.

Although FIG. 1 depicts singular elements, clearly the invention also applies to any plurality of elements.

The UCS 10 is a self-managing local store that acts as a persistent cache for various information related to electronic communications (e.g., e-mail) for an e-mail user 104. The UCS 10 aides the e-mail user 104 in providing a method to store untrusted certificates, e-mail addresses, and the like, that is both synchronized to reflect information in the directory 20, trusted certificate store 5, and the like, as well as, self-managing so as to remove or edit unwanted information (e.g., out of date, incorrect, obsolete, etc.). Ultimately, both off-line and on-line email communication is improved for the user 104 via their use of the UCS 10 of the present invention.

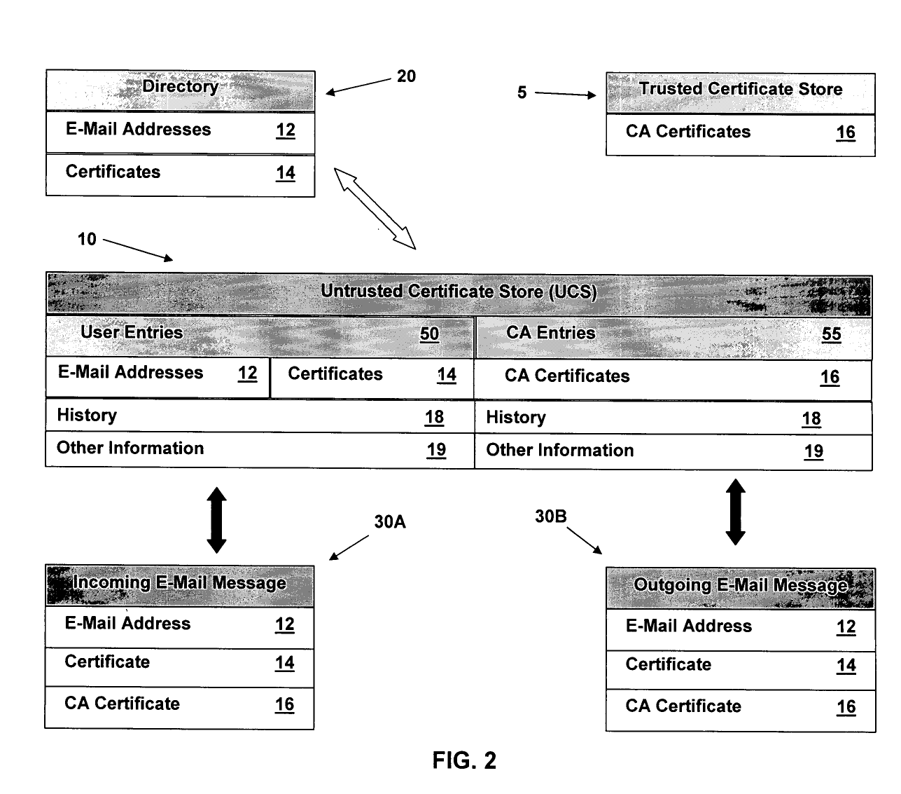

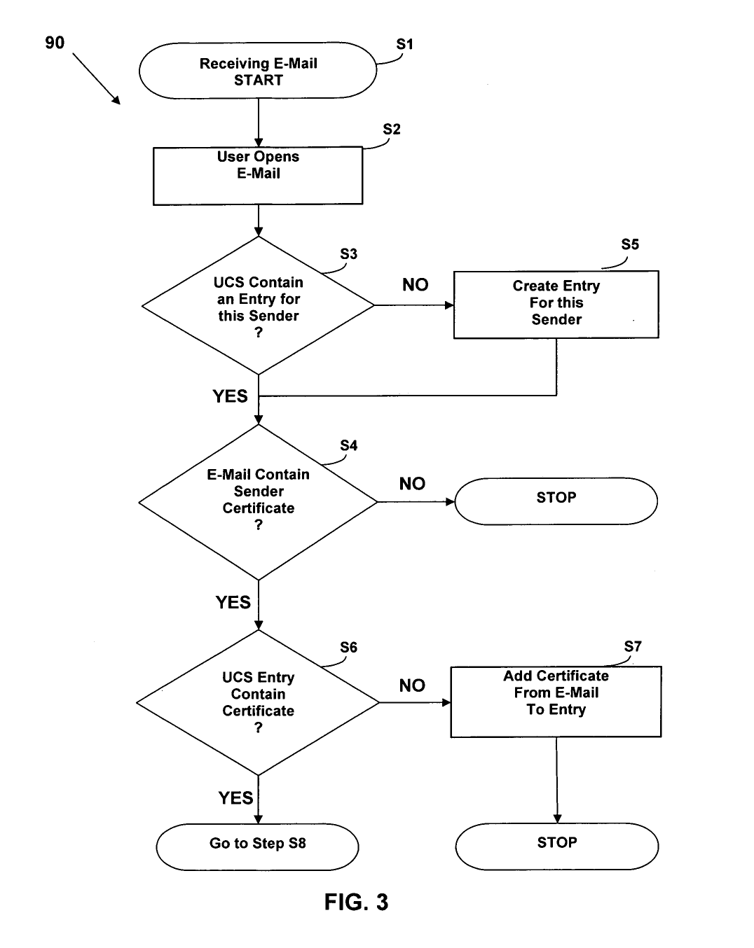

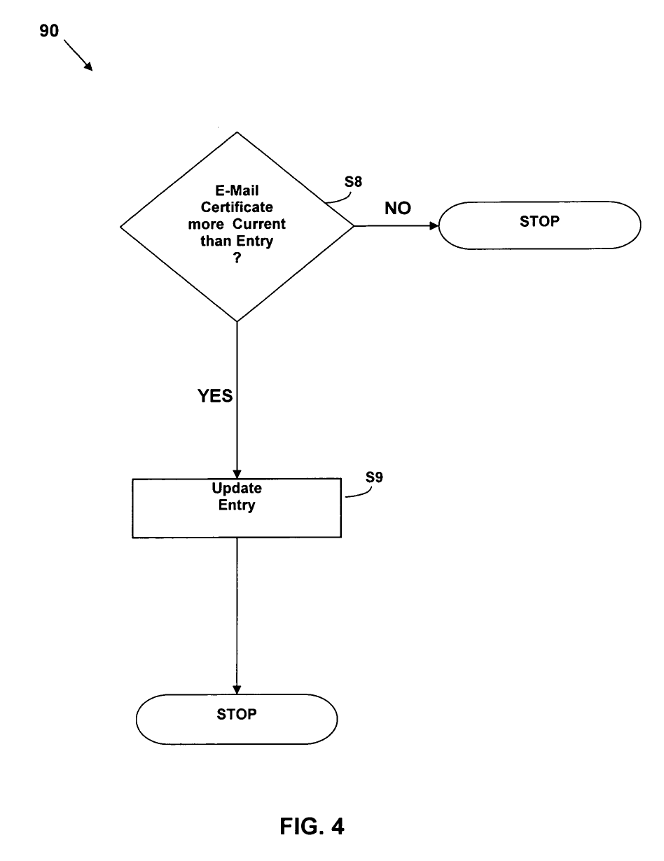

One aspect of the UCS 10 is how it handles e-mail messages 30 for the user 104. UCS 10 handles e-mail messages 30, be it both incoming e-mail messages 30A and outgoing e-mail messages 30B as viewed by a user 104A (FIG. 1). While FIG. 2 depicts a system wherein the UCS 10 inter alia receives an incoming e-mail message 30A, FIGS. 3 and 4 show one embodiment of a method 90 for receiving incoming e-mail messages 30A by the UCS 10.

An incoming e-mail message 30A sent to the user 104 may contain along with the de facto message one, or any combination, of: a sender's email address 12, an encryption certificate 14, and a Certificate Authority (CA) certificate 16. Some incoming e-mail messages 30A may alternatively contain a plurality of encryption certificates 14 and/or a plurality of CA certificates 16 with the sender's e-mail address 12. For example, the incoming e-mail message 30A may contain multiple encryption certificates 14 so as to allow the sender a choice of algorithms. More common is where the incoming e-mail message 30A contains multiple CA certificates 16 in the case where the encryption certificate 14 was issued by a non-root CA. In this scenario, there may be contained the sender's encryption certificate 14, a CA certificate 16 for the CA that issued the encryption certificate 14, and a complete chain of CA certificates 16 back to a public root CA.

Any e-mail address(es) 12 in the message 30A are automatically stored in the UCS 10, wherein the UCS 10 saves the address 12. Any encryption certificate(s) 14 in the message 30A are automatically stored and saved in the UCS 10, if either the encryption certificate 14 is not already in the UCS 10 or if there is not a more current encryption certificate 14 already in the UCS 10.

The UCS 10 then periodically and automatically synchronizes any stored and saved certificate 14 within the UCS 10 with certificates 14 stored in the directory 20. For example, if a particular certificate 14 is saved in the UCS 10, and then upon comparison with the directory 20 that changes have been made to the certificate 14 in the directory 20, these changes in the directory 20 certificate 14 will be replicated in the certificate 14 in the UCS 10.

Contrastingly, if the certificate 14 in the UCS 10 does not exist in the directory 20, then the certificate 14 is left unchanged in the UCS 10.

Similarly, during synchronization between UCS 10 and directory 20, additional certificates 14 may be discovered in the directory 20 that belong to, or are associated with, users (e.g., e-mail addresses 12) that exist in the UCS 10. In this situation, these certificates 14 may be added to the UCS 10 from the directory 20.

The incoming e-mail message 30A may additionally contain a CA certificate 16 that is needed to establish trust in the encryption certificate 14. The UCS 10 will store the CA certificate 16 in the attempt to provide future trust verifications. Additionally, if a CA certificate 16 is stored in the UCS 10 by the user 104 but not yet explicitly trusted by the user 104, this is an indication that the user 104 does have an interest in that particular Certificate Authority (CA).

One embodiment of a method 90 for receiving an incoming e-mail message 30A is shown in FIGS. 3 and 4. Upon receiving the incoming e-mail message 30A, step S1, the user 104 opens the email in step S2. Certain comparisons are then sequentially made between the incoming e-mail message 30A and the current information contained in the UCS 10. First, at step S3, a query is made if the UCS 10 contains an entry for the sender of this particular incoming e-mail message 30A. If the answer to step S3 is negative, then step S5 follows, wherein an entry for this particular sender is created, and the method 90 continues on to step S4. If step S3 is positive, then step S4 immediately follows wherein it is determined if the incoming e-mail message 30A contains a sender certificate 14. If a certificate 14 does not exist, in step S5, then the method 90 stops. If the incoming e-mail message 30A does contain a certificate 14 for the sender (i.e., the answer to step S4 is positive), then in step S6, a query is made of the UCS 10, namely comparing to check if the UCS 10 contains a certificate 14. If step S6 results in the negative, then step S7 follows wherein a certificate 14 is added from the incoming e-mail message 30A to the entry. Conversely, if step S6 results in a positive, then step S8 follows (see FIG. 4), wherein a comparison is made between the currency of the certificate 14 associated with the incoming e-mail message 30A and with that of the certificate 14 in the UCS 10. Step S9 calls for the updating of the certificate 14 in the UCS 10 with the more current certificate 14 in the incoming e-mail message 30A should it be required.

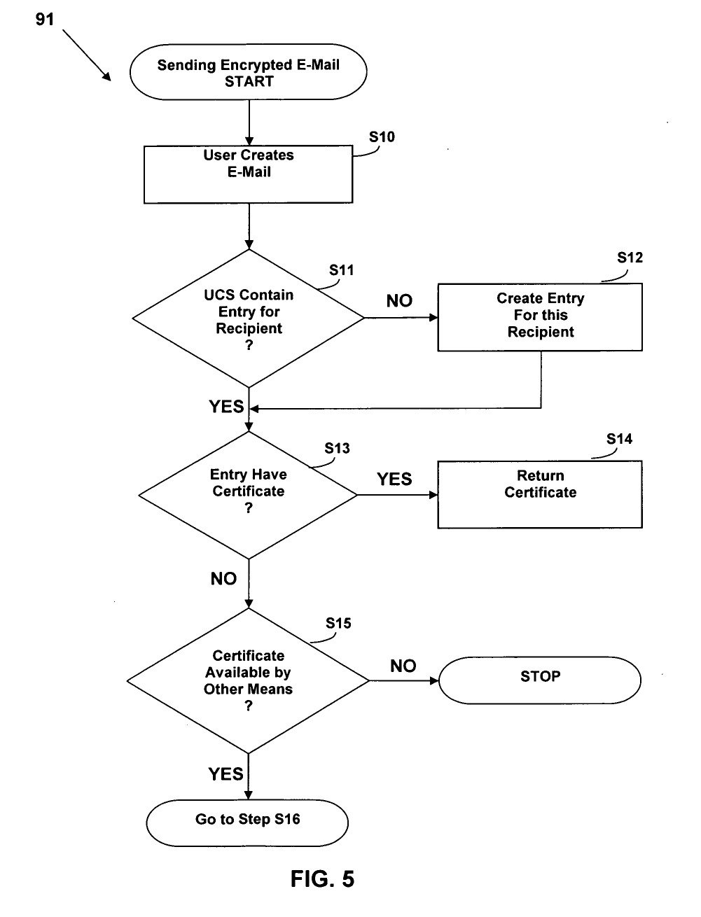

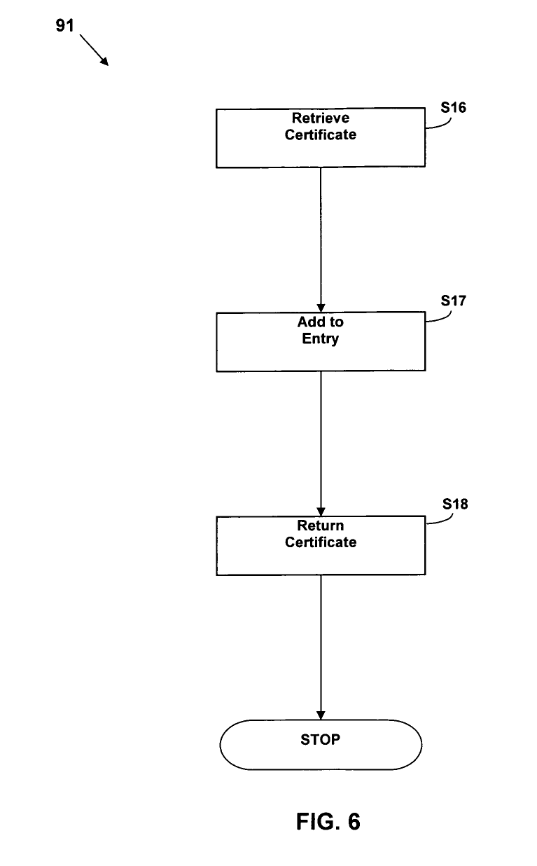

The UCS 10 of the present invention also handles situations wherein when an outgoing e-mail message 30B (FIG. 2) is sent by the user 104. One embodiment of a method 91 for sending an encrypted outgoing e-mail message 30B is depicted in FIGS. 5 and 6.

If the user 104 is attempting to send an encrypted outgoing e-mail message 30B, the UCS 10 is checked to see if the requisite certificate 14 is in the UCS 10. If the user 104 is operating in an “on-line” mode, however, the user 104 may obtain the current, requisite certificate 14 from the directory 20. Conversely, if the user 104 is operating “off-line”, then the directory 20 is not immediately available. However, because the synchronization process is run periodically between directory 20 and UCS 10, current, or near current, information in the directory 20 (e.g., certificate 14) is too available directly from the UCS 10. If the certificate 14 is not available from the UCS 10 and the user 104 is operating off-line (i.e., directory 20 is not immediately available), then the outgoing e-mail message 30B may not be encrypted for the particular recipient until the user 104 goes on-line again. In this manner and by periodic, automatic synchronization and maintenance, the UCS 10 will reflect information (e.g., certificates 14, etc.) in the directory 20. The periodic updating and synchronization, for example, may be done automatically whenever the user 104 is on-line (i.e., connected to the directory 20).

Turning to FIGS. 5 and 6, a user 104 creates an outgoing e-mail message 30B in step S10. Then in step S11, the UCS 10 is checked to see if there exists an entry for the e-mail recipient. If no entry exists, in step S12 the system creates an entry for this recipient. In either event, step S13 follows wherein the system checks to verify if the entry has a certificate 14. If a certificate 14 exists, step S14 returns the certificate 14 so as to allow the user 104 to send encrypted outgoing e-mail message 30B. However, if the entry does not have a certificate 14, the system, in step S15, checks to see if a certificate 14 is available by other means. If not, then the outgoing e-mail message 30B may only be sent unencrypted. If the certificate 14 is available by other means, then steps S16 through S18 (FIG. 6) follow, wherein the certificate 14 is retrieved, then added to the entry, and then returned whence it was retrieved. Thus, in this final scenario, the outgoing e-mail message 30B sent is encrypted, as well.

Thus, ultimately the UCS 10 stores and updates automatically users (e.g., e-mail addresses 12) of any certificates 14 received for those e-mail addresses 12, as well as collects additional certificates 14 for the same user. The UCS 10 will also store and update e-mail addresses 12 for incoming e-mail messages 30A that did not have certificates 14 associated therewith. That is, these e-mail addresses 12 will act as “placeholder” entries for potentially future secure e-mail messages 30 (i.e., with encryption certificate 14). Thus, these placeholder entries may, at a future synchronization time, obtain concomitant certificate(s) 14 from the directory 20, thereby allowing the secure communication in the future.

The UCS 10 may be periodically refreshed and/or updated by adding and/or removing certificates 14 from it so as to prevent unchecked growth of the information in the UCS 10. Various methods may be employed to maintain the UCS 10 including, for example, retaining certificates 14 that have been used in sending encrypted outgoing e-mail messages 30B over retaining certificates 14 that have been obtained by incoming e-mail messages 30A that have not been successively used again (or used in a particular period of time). Similarly, unused, received certificates 14 stored in the UCS 10 that were obtained via incoming e-mail message 30A, may be retained over unused certificates 14 that are obtained from the directory 20. Additionally, a time duration (e.g., time of receipt, time of use, etc.) element may be used in determining whether to retain or remove a particular certificate 14 from the UCS 10.

In addition to automatically adding certificates 14 (i.e., from e-mail messages 30 or directory 20), certificates 14 may be added manually to the UCS 10. This is a useful function to provide to the user 104 in the situation where the user 104 will be disconnected form the directory 20 (i.e., operating “off-line”), yet wishes to exchange secure e-mail messages 30. Additionally, attributes of an e-mail system employed by the user 104 may include an address-book function wherein any explicit “add user to address book” type operation also adds the user information (e.g., certificate 14) to the UCS 10 so that certificates 14 may be retrieved by the user 104 during off-line operation.

In this manner the UCS 10 is acting at least as a partial, and possibly a total, replica of the directory 20, as well as, an additional repository of certificates 14 (i.e., non-directory certificates) that have been obtained through e-mail messages 30. The certificates 14 in the UCS 10 are untrusted in that their validity must be established prior to use by verifying their signatures and determining their trust. The UCS 10 thus acts as a local store, or mechanism, for the user 104 during off-line use and/or when the requisite certificate 14 is, perhaps, not present in the directory 20.

As shown in FIG. 2, the UCS 10 stores various information that are from user entries 50 and various information that are CA entries 55. The user entries 50 may include e-mail addresses 12, certificates 14, history 18 and other information 19 that have been used in communication and/or are of interest to the user 104. The CA entries 55 may include CA certificates 16, history 18 and other information 19 that have been used in communication and/or are of interest to the user 104. The history 18 may include, for example, various time-stamps such as when an entry (e.g., e-mail address 12) was created in the UCS 10; when a certificate 14 in the entry was received in incoming e-mail 30A; when the last time a certificate 14 was used to encrypt an outgoing e-mail message 30B, and the like.

The history 18 may also include, for example, various counts such as the number of times the certificate 14 has been received, the number of times the certificate 14 has been used with an outgoing e-mail message 30B.

The UCS 10 may also store other useful information 19 that is available to the mail client that could indicate the usefulness of the certificate 14 to the user 104. For example, the useful information 19 may be a SPAM index assigned to the e-mail address 12 for incoming e-mail message 30A having a certificate 14. An e-mail system may calculate a SPAM index for each and every incoming e-mail message 30A that reflects an assessment (e.g., applies an algorithm) of how likely, or unlikely, the e-mail message 30A is to be considered SPAM by the user 104. Although the sender's e-mail address 12 may be used in calculating the SPAM index for a particularly incoming e-mail message 30A, the SPAM index is derived from, and associated with the particular incoming e-mail message 30A.

Other useful information 19 may include the reason, or source, for the particular information be it the use of, or obtaining of, a certificate 14, e-mail address 12, and/or CA certificate 16. For example, the reason may be received in incoming e-mail message 30A versus required in sending an encrypted outgoing e-mail message 30B.

Thus, for example, if a certificate 14 is used, but is already in the UCS 10, the appropriate time stamp, if used, is updated and the appropriate count, if used, is incremented, and other useful information 19 updated, if appropriate.

Conversely, if a certificate 14 is used that does not exist in the UCS 10, the certificate 14 may be added to the UCS 10 with applicable time stamp, if used, and with the appropriate count initialized to “1”, if used.

When the user 104 and UCS 10 are operating in a connected mode (i.e., “on-line”), wherein the directory 20 may be connectable, the present invention may automatically synchronize the UCS 10 with the directory 20. That is, the UCS 10 will attempt to update and/or augment the UCS 10 with certificates 14, and other information from the directory 20.

The synchronization includes retrieving from the directory 20 all certificates 14 for the user 104. Also, if certificates 14 were received, then for each received certificate 14, if it contains a key not currently in the UCS 10, it shall be added to the UCS 10. If the received certificate 14 does have a key in the UCS 10, the UCS 10 will be updated with the “best” certificate(s) 14 for that key. Often “best” certificate 14 may mean the most recent certificate 14 suitable for sending an encrypted outgoing e-mail message 30B.

By time-stamping information in history 18, including certificates 14, old certificates 14 may be removed from the UCS 10. For example, certificates 14 that have not been used in a particular period of time, may be automatically removed. This automatic removal may be triggered when a duration of time of non-use is met and/or when the size of the UCS 10 reaches a pre-determined amount. So too by time-stamping both sending (i.e., using), and receiving, of certificate 14 with e-mail message 30 allows, for example, preferentially retaining certificates 14 that have been used over certificates 14 that have merely been received, but not used.

Similarly, if other information 19 stored includes a SPAM index, then certificates 14 obtained from incoming e-mail message 30A with a “high” SPAM index may be discarded earlier than incoming e-mail message 30A received that is legitimate. Also, if using the “count” feature, certificates 14 that have a higher count for receiving and/or sending may concomitantly be retained during longer non-use periods than certificates 14 with low counts.

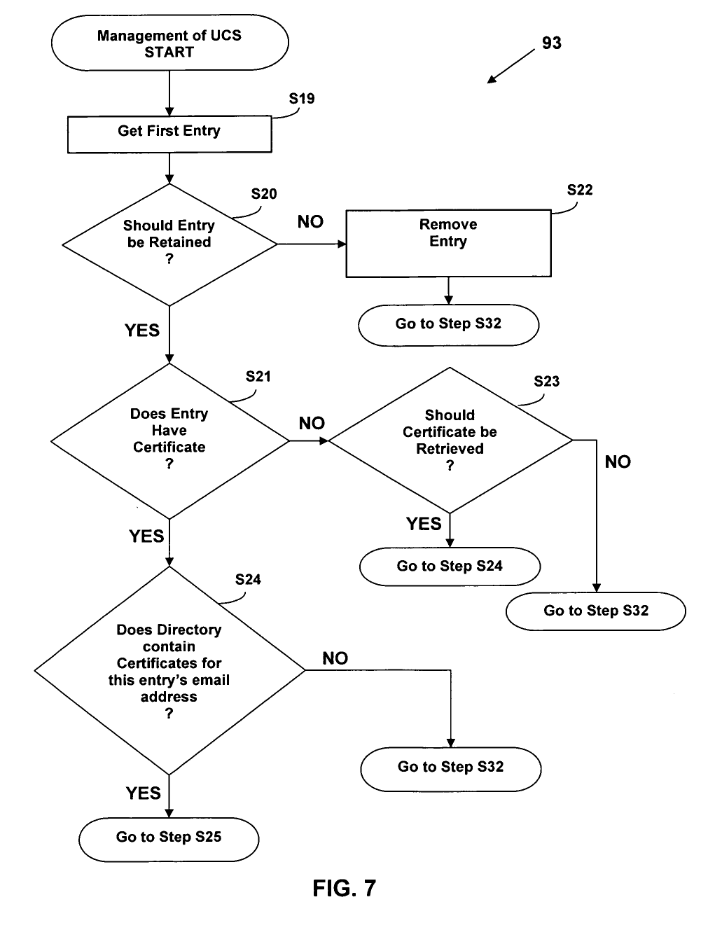

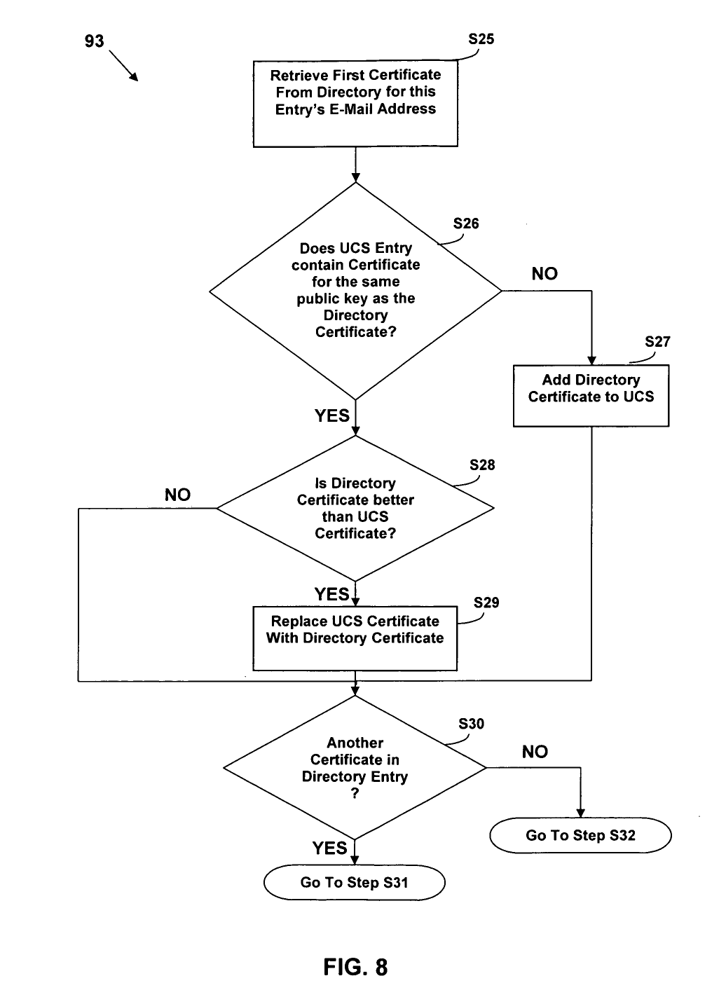

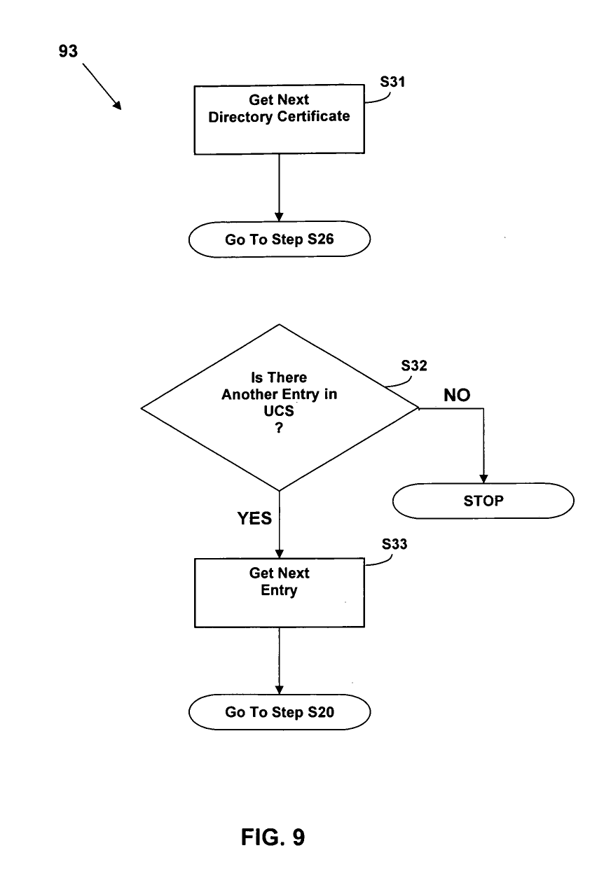

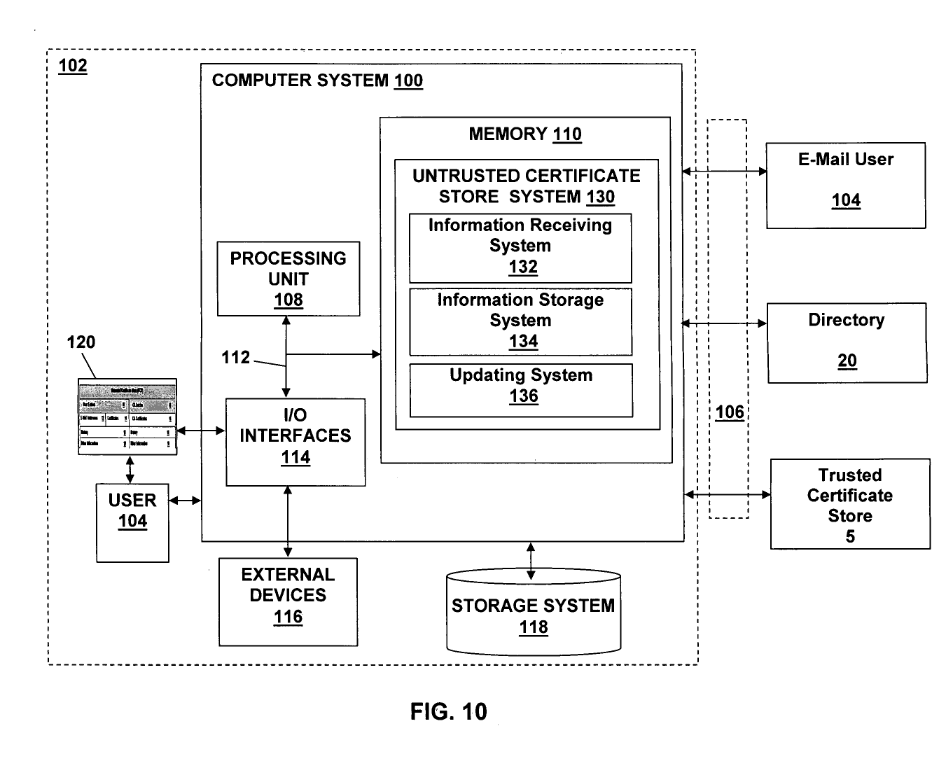

An embodiment of a method of the periodic and automatic synchronizing and maintenance of the UCS 10 is depicts by a 93 in FIGS. 7 through 9. The method 93 ultimately synchronizes the directory 20 with the UCS 10. Step S19 (FIG. 7) starts with obtaining the first entry in the UCS 10. The entry may include an e-mail address 12. Step S20 follows where the entry is evaluated to check whether it should be retained in the UCS 10 or not. Depending on the evaluation technique employed, step S20 may determine that the entry should be removed at step S22. Upon removal of the entry, then the method 93 goes to step S32 (FIG. 9) to determine if there are additional entries in the UCS 10 and, if applicable, retrieve the entries.

If the entry should be retained, then step S21 follows which queries whether the entry has a certificate 14. If there is no certificate 14 for the particular entry 12, then step S23 follows to query if a certificate 14 should be retrieved for the entry. If S23 is positive, then step S24 follows. If the certificate should not be retrieved, then step S32 (FIG. 9) follows querying for additional entries in the UCS 10.

Step S24 queries whether or not the directory 20 contains certificate(s) 14 for this entry's e-mail address 12. If step S24 is negative, then the method 93 proceeds to step S32 (FIG. 9) to query for additional entries in the UCS 10.

If step S24 is positive, then step S25 at FIG. 8 follows to retrieve the first certificate 14 from the directory 20 for this entry's e-mail address 12. Upon retrieving the certificate 14, step S26 follows to query whether the UCS entry contains a certificate for the same public key as the directory certificate. If step S26 is negative, step S27 follows wherein a directory certificate is added to UCS 10. After step S27, step S30 follows to query for another certificate in the directory entry.

Back at step S26, if the query is positive, another query, step S28, follows. In step S28, a comparison is made between the directory certificate and the UCS certificate. If the directory certificate is better than the UCS certificate, then the method 93 replaces (i.e., updates) the UCS certificate with the directory certificate (step S29) and continues on to step S30 to query whether there is another certificate in the directory entry.

Conversely, if the directory certificate is not better than the UCS certificate (i.e., step S28 is negative), then step S30 immediately follows to query for another certificate in the directory entry. Step S30 queries for additional certificates in the directory entry. If step S30 is negative (i.e., no remaining certificates in directory entry), then step S32 follows (FIG. 9). If there is another certificate in the directory entry, step S31 (FIG. 9) follows to retrieve the next directory certificate. After step S31, the method 93 returns to step S26 (FIG. 8) to resume with evaluating the certificate, as discussed above.

Ultimately, step S32 acts as a loop to continually get the next entry (step S33) and via steps S20 through S31 synchronize, as applicable, the entries and certificates 14 in the UCS 10 with the information in the directory 20 until all the entries and certificates 14 in the UCS 10 are automatically updated, thereby ultimately resulting in a UCS 10 that is automatically maintained and updated.

Note that while the present invention includes for the automatic and periodic maintenance of information stored in the UCS 10, there may be an embodiment that also allows for the manual initiation and/or maintenance of information in the UCS 10 by the user 104 (e.g., user 104 overrides). The present invention ultimately provides the advantage of a maintained untrusted certificate store for secure e-mail.

A computer system 100 for providing an untrusted certificate store for secure e-mail in accordance with an embodiment of the present invention is depicted in FIG. 9. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service for providing an untrusted certificate store for secure e-mail, in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as an Untrusted Certificate Store System 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. Moreover, computer system 100 is only representative of the many types of computer systems that can be used in the practice of the present invention, each of which can include numerous combinations of hardware/software. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 9 can be included in computer system 100. However, if computer system 100 comprises a handheld device or the like, it is understood that one or more external devices/resources 116 (e.g., display 120) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. Moreover, although not shown, computer systems operated by user 104 can contain computerized components similar to those described above with regard to computer system 100.

Shown in memory 110 (e.g., as a computer program product) is an Untrusted Certificate Store System 130 for providing an Untrusted Certificate Store (UCS) 10 for secure e-mail, in accordance with embodiment(s) of the present invention. The Untrusted Certificate Store System 130 generally includes an information receiving system 132 for receiving one, or both, of an untrusted certificate 14 and e-mail address 12 from an e-mail message, as described above. The Untrusted Certificate Store System 130 generally includes an Information Storage System 134 for storing the received information in a persistent cache, as described above. Further, the Untrusted Certificate Store System 130 generally also includes an Updating System 136 for automatically updating the received and stored information, as described above.

The present invention can be offered as a business method on a subscription or fee basis. For example, one or more components of the present invention can be created, maintained, supported, and/or deployed by a service provider that offers the functions described herein for customers. That is, a service provider can be used to provide a service for providing an untrusted certificate store for secure e-mail, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive nor to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method of providing an untrusted certificate store (UCS) for secure e-mail, comprising the steps of:
obtaining information from one selected from the group consisting of an e-mail message and a directory, wherein the information comprises at least one of an untrusted certificate and an e-mail address;
storing the information in an UCS; and
automatically maintaining the information.

2. The method of claim 1, wherein the automatic maintaining step is periodic.

3. The method of claim 1, wherein the e-mail message is selected from the group consisting of: a message sent to a user and a message generated by a user.

4. The method of claim 1, wherein the automatic maintaining step comprises synchronizing the information with a directory.

5. The method of claim 1, wherein the automatic maintaining step comprises removing at least a portion from the stored information or adding at least a portion to the stored information.

6. The method of claim 1, further comprising:
sending a secure e-mail message employing the information.

7. The method of claim 6, wherein the sending step is done off-line.

8. The method of claim 1, wherein the storing step further comprises storing a history related to the e-mail message.

9. The method of claim 1, wherein the information received further comprises a Certificate Authority (CA) certificate.

10. The method of claim 1, further comprising:
manually initiating a maintenance of the information.

11. A system for providing an untrusted certificate store (UCS) for secure e-mail comprising:
a system for obtaining information from one selected from the group consisting of an e-mail message and a directory, wherein the information comprises at least one of an untrusted certificate and an e-mail address;
a system for storing the information in an UCS; and
a system for automatically maintaining the information.

12. The system of claim 11, wherein the system for automatic maintaining updates on a periodic basis.

13. The system of claim 11, wherein the e-mail message is selected from the group consisting of: a message sent to a user and a message generated by a user.

14. The system of claim 11, wherein the automatic maintaining system comprises a system for synchronizing the information with a directory.

15. The system of claim 11, wherein the automatic maintaining system further comprises a system for removing at least a portion from the stored information or a system for adding at least a portion to the stored information.

16. The system of claim 11, further comprising:
a system for sending a secure e-mail message employing the information.

17. The system of claim 16, wherein the sending system sends off-line.

18. The system of claim 11, wherein the storing system further comprises a system for storing a history related to the e-mail message.

19. The system of claim 11, wherein the information received further comprises a Certificate Authority (CA) certificate.

20. The system of claim 11, further comprising:
A system for manually initiating a maintenance of the information

21. A program product stored on a computer readable medium for providing an untrusted certificate store (UCS) for secure e-mail, the computer readable medium comprising program code for performing the steps of:
obtaining information from one selected from the group consisting of an e-mail message and a directory, wherein the information comprises at least one of an untrusted certificate and an e-mail address;
storing the information in an UCS; and
automatically maintaining the information.
